(19) United States
(12) Patent Application Publication
(10) Pub. No.: US 2024/0030852 A1
(43) Pub. Date: Jan. 25, 2024

(54) METHOD FOR DETERMINING CORRECTION INFORMATION, METHOD FOR CONTROLLING AN ELECTRIC MACHINE, APPARATUS, ELECTRICAL DRIVE DEVICE, AND HEAT PUMP

(71) Applicant: Robert Bosch GmbH, Stuttgart (DE)

(72) Inventors: David Gaenzle, Leinfelden-Echterdingen (DE); Maximilian Manderla, Oberursel (DE); Fabian Schmid, Esslingen (DE)

(21) Appl. No.: 18/255,159

(22) PCT Filed: Dec. 1, 2021
(86) PCT No.: PCT/EP2021/083704

§ 371 Date: May 31, 2023

(30) Foreign Application Priority Data
Dec. 1, 2020 (DE) 10 2020 215 121.0

(51) Int. Cl. H02P 23/14; F25B 31/02

(52) U.S. Cl. CPC H02P 23/14; F25B 31/026

(57) ABSTRACT

The invention relates to a method for determining correction information for an electric machine (7) which has a stator winding and a rotatably mounted rotor having multiple pole pairs, wherein a reference rotational angle (φRef) of the rotor is selected; an actual variable influenced by a rotation of the rotor is determined and is monitored for interference waves (SW); when an interference wave (SW) is detected, an interference-wave correction instruction which is based on the reference rotational angle (φRef) and is intended for compensating for the detected interference wave (SW), and a reference feature of the interference wave (SW) based on the reference rotational angle (φRef) are determined; a reference rotational angle value of the reference rotational angle (φRef) is determined on the basis of a rotational angle interval (Δφel) covered during an electrical revolution of the rotor; and the determined interference-wave correction instruction, the determined reference feature and the determined reference rotational angle value are assigned to one another and stored as correction information.

### BACKGROUND

The invention relates to a method for determining correction information for an electric machine comprising a stator winding and a rotatably mounted rotor having multiple pole pairs.

In addition, the invention relates to a method of controlling such an electric machine.

Further, the invention relates to a device for determining a correction instruction with a control unit.

In addition, the invention relates to a device for operating an electric machine having a control unit.

The invention also relates to an electrical drive device and a heat pump.

An electric machine typically comprises a rotatably mounted rotor, as well as a stator having a stator winding. The stator winding is arranged in a distributed manner around the rotor such that the rotor is rotatable by a suitable powering of the stator winding. Rotary field machines, such as cage-type asynchronous machines or permanently-magnetic synchronous machines, do not have an ideal sinusoidal flow distribution in the air gap due to their design. In operation, when controlled with sinusoidal currents, this results in non-uniform torques with harmonic waves. In addition to the torsion vibrations in the drive train caused by this, the aforementioned non-uniformities also result in radial force excitations between the stator and rotor, which directly manifest themselves in the form of housing vibrations and consequently noise vibration harshness (NVH). The problem is reinforced by external oscillating load torques, for example by a compressor. Overall, the structural properties of the electrical drive system consequently cause undesirable, noticeable vibrations in the drive train, in the electrical grid and/or acoustically perceptible sound emissions. It is known to control electric machines by means of the field-oriented control. This control is essentially designed to regulate the fundamental wave of the current, wherein the fundamental wave of the current is transformed into zero-frequency variables by means of the d/q transformation, in a coordinate system that rotates with the rotor. These zero-frequency variables are also referred to as torque-forming current iq and flow-forming current id. The zero-frequency variables are controlled in the rotor fixed coordinate system, and the determined variables ud, uq are subsequently back-transformed and used as the fundamental wave of the voltage to control the electric machine. It is not possible to influence or reduce harmonics in this manner.

It is known from the prior art to compensate for a harmonic behavior of an electric machine by altering the actuation of the electric machine. For example, an as yet unpublished patent application of the applicant discloses a method according to which the compensation is carried out by means of a predetermined interference-wave correction instruction, namely a control matrix in the present case.

### SUMMARY

A method for determining correction information for an electric machine comprising a stator winding and a rotatably mounted rotor having multiple pole pairs is provided. The method according to the invention is characterized by a reference rotational angle of the rotor is selected, that an actual variable influenced by rotation of the rotor is determined and monitored for interference waves; that, when an interference wave is detected, an interference-wave correction instruction related to the reference rotational angle is determined to compensate for the detected interference wave, as well as a reference feature of the interference wave related to the reference rotational angle; that a reference rotational angle value of the reference rotational angle is determined based on a rotational angle interval which is covered in an electrical revolution of the rotor; and that the determined interference-wave correction instruction, the determined reference feature and the determined reference rotational angle value are associated with each other and stored as correction information.

If the rotor has multiple pole pairs, the electrical rotational angle of the rotor passes through a rotational angle interval of n*360° in a mechanical revolution of the rotor, wherein n is the number of pole pairs. If, for example, two pole pairs are present, the electrical rotational angle passes through a rotational angle interval of 720°. If three pole pairs are present, the electrical rotational angle passes through a rotational angle interval of 1080°, respectively. For each pair of poles of the rotor, the electrical rotational angle thus passes through a rotational angle interval of 360° in a mechanical revolution of the rotor. Accordingly, in a mechanical revolution of the rotor, the rotor passes through a number of electrical revolutions corresponding to the number of pole pairs. If multiple pole pairs are present, a unique allocation to a mechanical rotational angle of the rotor is not possible based on the rotational angle value of the electrical rotational angle alone. For example, if two pole pairs are present, either a first mechanical rotational angle or a second mechanical rotational angle shifted by 180° can be present at an electrical rotational angle with a rotational angle value of 0°.

If a control of an electric machine with multiple pole pairs is to compensate for harmonic wave behavior of the electric machine by consideration of an interference-wave correction instruction, it is necessary to correctly determine the phase position of the interference-wave correction instruction. A rotational angle sensor is usually provided for this purpose, which is designed to sense the mechanical rotational angle of the rotor. In contrast, the method according to the invention has the advantage that the corrective information determined according to the invention contains the interference-wave correction instruction on the one hand, and information by means of which the phase position of the interference-wave correction instruction can be correctly determined without a rotational angle sensor for sensing the mechanical rotational angle on the other hand.

According to the invention, it is provided that a reference rotational angle of the rotor is selected. For example, a particular mechanical rotational angle of the rotor is selected as the reference rotational angle. Preferably, a particular mechanical rotational angle of the rotor is selected as the reference rotational angle. Preferably, an electrical rotational angle is selected as the reference rotational angle from an electrical rotational angle interval which is covered in a mechanical revolution of the rotor. For example, if three pole pairs are present, an electrical rotational angle is selected from an electrical rotational angle interval of 1080°. The rotational angle that is selected as the reference rotational angle is generally arbitrary. For example, an electrical rotational angle of 0° is selected as the reference rotational angle from the electrical rotational angle interval of 1080°. According to the invention, it is also provided that an actual variable influenced by the rotation of the rotor is determined and monitored for interference waves. An actual variable is to be understood as a quantity in the course of which the harmonic wave behavior of the electric machine is recognizable as an interference wave. When an interference wave is detected, an interference-wave correction instruction related to the reference rotational angle is determined to compensate for the sensed interference wave, as well as a reference feature of the interference wave that is related to the reference rotational angle. An interference-wave correction instruction to compensate the sensed interference wave is to be understood to refer to data, the consideration of which when actuating the electric machine results in the interference wave being compensated. For example, the control matrix mentioned above is an interference-wave correction instruction. The interference-wave correction instruction is related to the reference rotational angle. In order to compensate for the interference wave, a periodic change in the actuation of the electric machine is necessary. In this respect, the interference-wave correction instruction itself is also periodic. For example, the interference-wave correction instruction is related to the reference rotational angle in that the interference-wave correction instruction has a particular phase position relative to a reference rotational angle. The reference feature of the interference wave is to be understood as a particular feature of the interference wave. The reference feature is also related to the reference rotational angle. For example, the interference wave possesses the reference feature if the rotational angle of the rotor corresponds to the reference rotational angle. According to the present invention, a reference rotational angle value of the reference rotational angle is also determined, based on a rotational angle interval that is covered during an electrical revolution of the rotor. As the rotor comprises multiple pole pairs, each rotational angle value of the electrical rotational angle interval that is covered during an electrical revolution of the rotor occurs several times in a mechanical revolution of the rotor. Finally, the determined interference correction instruction, the determined reference feature and the determined reference rotational angle value are associated with each other, and are saved as correction information. The interference-wave correction instruction is thus stored depending on the determined reference feature and depending on the determined reference rotational angle value. The reference feature and the reference rotational angle value together allow a correct determination of the phase position of the interference-wave correction instruction. The term “determination” as used in the disclosure is to be understood to include both sensing or measuring and calculating depending on sensed or measured values. Preferably, the method according to the invention is carried out for determining a correction information as part of the application of the electric machine in the plant.

According to a preferred embodiment, it is provided that the interference-wave correction instruction is determined in dependence on a sensor signal of an NVH sensor. Depending on the sensor signal of the NVH sensor, a precise determination of the interference-wave correction instruction is possible. For example, the actuation of the electric machine is adjusted to minimize the sensor signal of the NVH sensor. The interference-wave correction instruction is then determined depending on the actuation adjustment that is made. Preferably, an accelerometer, a laser sensor, or an acoustic sensor is used as the NVH sensor. Preferably, the NVH sensor is an external sensor. Accordingly, the NVH sensor is not part of the electric machine, but is merely associated with the machine to perform the method. For example, the NVH sensor is part of an external correction device.

Preferably, at least one actual electrical phase current flowing through the stator winding is determined as the actual variable. During operation of the electric machine, the actual phase currents flowing through the stator winding themselves have a sinusoidal or periodic path. The interference waves are detectable in the course of the actual phase currents based on the amplitude of the actual phase current. Determining an actual phase current as the actual variable is particularly suitable because the actual phase currents are generally determined by the standard sensors of the electric machine in any case.

According to a preferred embodiment, it is provided that the torque-forming current is determined as the actual variable. As mentioned above, this is related to a rotor-fixed coordinate system and is correspondingly present as a zero-frequency variable. Since the torque-forming current is a zero-frequency variable, the interference waves are particularly easily detectable. Alternatively or additionally, the flow-forming current is preferably determined as the actual variable.

Preferably, the machine is designed to drive a compressor, wherein a fluid pressure of a fluid conveyed through the compressor is determined as the actual variable. The rotor of the machine is then coupled to the compressor to drive it. Accordingly, harmonic wave behavior of the machine also transfers to the fluid pressure of the fluid that is conveyed by the fluid pump. Accordingly, the interference wave is also detectable in the course of the fluid pressure.

Preferably, a phase position of the interference wave is determined as the reference feature. Thus, the phase position of the interference wave is determined based on the reference rotational angle. The phase position is particularly suitable as a reference feature for characterizing the reference rotational angle, as explained in the following example. In this example, the rotor again has three pole pairs. Accordingly, the electrical rotational angle value that exists at the reference rotational angle of the rotor is present in a mechanical revolution of the rotor for a total of three times. The interference wave is assumed to be an interference wave that is the first harmonic wave with respect to the mechanical rotation frequency of the rotor. Accordingly, the phase position of the interference wave with respect to the reference rotational angle is different than with respect to one of the further rotational angles, in which the same electrical rotational angle value is present as the reference rotational angle. The reference rotational angle is accordingly clearly distinguishable from the further rotational angles based on the phase position of the interference wave.

According to a preferred embodiment, it is provided that at least one maximum and/or at least one minimum of the actual variable is determined as the reference feature. For example, the maximum or minimum immediately following the presence of the reference rotational angle is determined as the reference feature. The reference rotational angle can also be clearly characterized based on the maximum and the minimum.

A method of controlling an electric machine comprising a stator winding and a rotatably mounted rotor having multiple pole pairs is also provided. The method according to the invention for controlling the electric machine is characterized by corrective information which includes an interference-wave correction instruction and has a reference electrical rotational angle value and a reference feature is provided, that an actual variable influenced by rotation of the rotor is determined and monitored for interference waves, that upon sensing an interference wave for each electrical rotational angle of the rotor, its rotational angle value corresponds to the reference rotational angle value, that a respective actual feature of the interference wave related to the electrical rotational angle is determined, that the determined actual features are compared to the reference feature, that a phase position of the interference-wave correction instruction is determined depending on this comparison, and that control signals for the electric machine are determined depending on the interference-wave correction instruction with the determined phase position.

Preferably, a method of control is also understood to mean a method of actuation. In particular, the electric machine is actuated, preferably controlled, in this case.

The advantage is that with the standard sensor technology of the electric machine, a correct determination of the phase position of the interference-wave correction instruction can be made. Thus, no additional sensor technology, for example a rotational angle sensor, is necessary to compensate for interference waves that occur in the operation of the electric machine.

Preferably, corrective information is provided as corrective information which is determined using the method according to the invention for determining corrective information. Preferably, an actual electrical current flowing through the stator winding, the torque-forming current, the flow-forming current and/or a fluid pressure are determined as the actual variable. Preferably, a phase position of the interference wave, a maximum of the interference wave, or a minimum of the interference wave are determined as the actual feature. According to the invention, the determined actual features are compared with the reference feature that is included in the correction information, and a phase position of the interference-wave correction instruction is determined depending on the comparison. For example, the actual feature which least deviates from the reference feature is selected. It is then assumed that the rotational angle of the rotor associated with this actual feature corresponds to the reference rotational angle of the rotor. Since the interference-wave correction instruction was determined based on the reference rotational angle, the phase position of the interference-wave correction instruction can then be correctly determined accordingly. Finally, actuation signals for the electric machine are determined at the determined phase position depending on the interference-wave correction instruction. The electric machine is then controlled with the determined phase position depending on the interference-wave correction instruction.

The electric machine is preferably actuated, in particular controlled, by means of the determined actuation signals. The control and/or actuation of the electric machine is carried out by means of the determined actuation signals.

The invention also relates to a device for determining correction information for an electric machine, wherein the machine comprises a stator winding and a rotatably mounted rotor having multiple pole pairs. The device is characterized by a control unit which is specifically designed to perform the method according to the invention for determining corrective information, when used as intended. This also results in the advantages already mentioned with regard to the method.

The invention also relates to a device for controlling an electric machine, wherein the machine comprises a stator winding and a rotatably mounted rotor having multiple pole pairs. This device is characterized by a control unit specifically designed to perform the method according to the invention when used as intended for controlling an electric machine. This also results in the advantages already mentioned with regard to the method.

The electrical drive device according to the present invention comprises an electric machine and a device for operating the electric machine. The drive device is characterized by design of the device according to the invention. This, too, results in the aforementioned advantages.

The heat pump according to the invention comprises a compressor and an electrical drive device for driving the compressor. The heat pump is characterized by the design of the drive device according to the invention.

### BRIEF DESCRIPTION OF THE DRAWINGS

The invention will be explained in more detail in the following with reference to the drawings. The figures show:

FIG. 1 a heat pump in a schematic view,

FIG. 2 a method for determining correction information for an electric machine of the heat pump,

FIG. 3 a progression of electrical phase currents,

FIG. 4 a spectrum of a torque-forming current,

FIG. 5 a path of a fluid pressure, and

FIG. 6 a method for controlling the electric machine.

### DETAILED DESCRIPTION

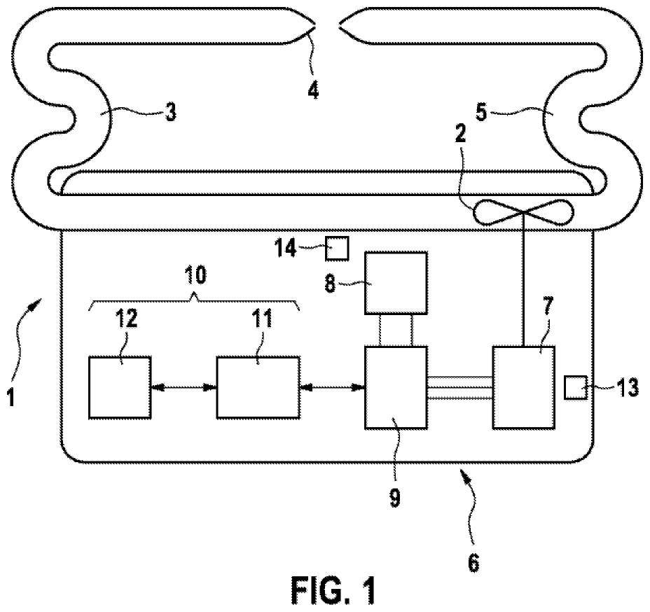

FIG. 1 shows a heat pump in a schematic view 1. The heat pump 1 comprises a compressor 2. In the present case, the heat pump 1 also comprises a condenser 3, a throttle 4 and a vaporizer 5. The compressor 2 is associated with an electrical drive device 6 for driving the compressor 2. In the present case, the compressor 2 is a twin rotary piston compressor 2. However, the advantageous effects achieved by the invention may also be achieved using a different type of compressor.

The drive device 6 comprises an electric machine 7 comprising a rotatably mounted rotor and a stator winding. The rotor has multiple pole pairs. In the following, to explain the invention, it is assumed that the rotor possesses three pole pairs. The stator winding is arranged in a distributed manner around the rotor such that the rotor is rotatable by a suitable powering of the stator winding. For this purpose, the stator winding comprises multiple phases. In the following, for explanation of the invention, it is assumed that the stator winding comprises three phases U, V and W.

The drive device 6 also comprises an electrical energy storage 8. The energy storage 8 is electrically connected to the phases of the stator winding by power electronics 9 comprising multiple switching elements.

The drive device 6 also comprises a device 10 for controlling the electric machine 7. In particular, an actuation without feedback is also to be understood as a control. In particular, an actuation without feedback is also to be understood as a control. A control can in particular also perform actuation. The device 10 comprises a control unit 11, which is designed to drive the electric machine 7. For this purpose, the control unit 11 is designed to determine actuation signals for the switching elements of the power electronics 9 and switch the switching elements in a conductive or non-conductive manner depending on the actuation signals. Using the actuation signals, the electric machine 7 is actuated, in particular controlled. The device 10 also comprises a data storage 12. At least one correction information is stored/storable in the data storage 12. The data memory 12 is connected to the control unit 11 by means of communication technology in order to provide the correction information to the control unit 11.

A first sensor device 13 is associated with the stator winding. The first sensor device 13 is designed to detect actual electrical phase currents flowing through the phases U, V and W of the stator winding. For this purpose, the first sensor device 13 comprises at least one current sensor. The first sensor device 13 is connected with communication technology to the control unit 11 to provide the sensed actual phase currents to the control unit 11.

The heat pump 1 also comprises a second sensor device 14. The second sensor device 14 is designed to sense a fluid pressure of a fluid conveyed by the compressor 2. For this purpose, the second sensor device 14 comprises at least one pressure sensor. The second sensor device 14 is connected with communication technology to the control unit 11 to provide the sensed fluid pressure to the control unit 11.

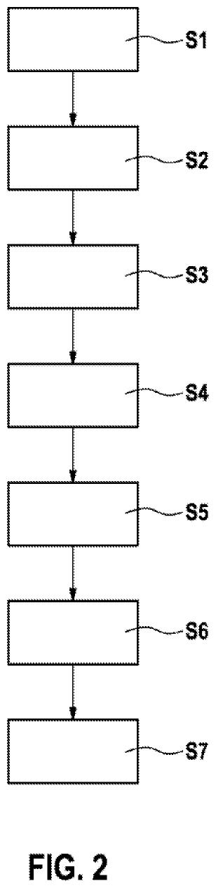

Referring now to FIG. 2, an advantageous method for determining correction information for the electric machine 7 will be explained in further detail. The method is performed by control unit 11.

In a first step S1, the electric machine 7 is operated by means of a field-oriented control based on an estimated electrical rotational angle. Audible or noticeable vibrations occur during the operation of the machine 7. Such vibrations result from the construction properties of the machine 7 on the one hand and from the compression cycles of the compressor 2 driven by the machine 7 on the other hand.

In a second step S2, a reference rotational angle φRef of the rotor is selected. In so doing, a particular electrical rotational angle of the rotor is selected as the reference rotational angle φRef from a rotational angle interval, which is covered in a mechanical revolution of the rotor. Since the rotor comprises three poles pairs, the electrical rotational angle passes through a rotational angle interval of 1080° in one mechanical revolution of the rotor. The selection of the reference rotational angle φRef is arbitrary in principle. For example, an electrical rotational angle of 0° or 540° is selected as a reference rotational angle φRef. The following assumes that an electrical rotational angle of 0° is selected as the reference rotational angle φRef.

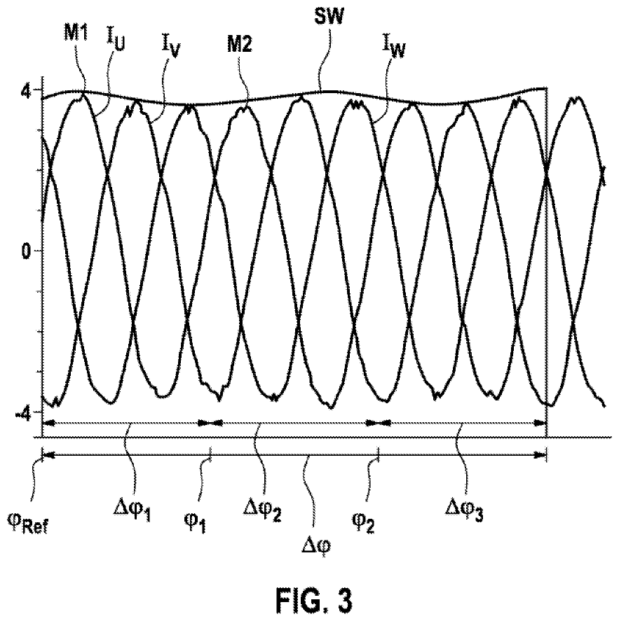

In a third step S3, an actual variable influenced by rotation of the rotor is determined and monitored for interference waves. Since the actual variable is influenced by the rotation of the rotor, the vibrations discussed above are detectable as interference waves over the course of the actual variable. Different variables can be considered as actual variables, as explained below with regard to FIGS. 3 to 5.

For this purpose, FIG. 3 shows a diagram in which the curve of the actual phase currents IU, IV and IW is shown depending on the mechanical rotational angle of the rotor. The rotational angle interval Δφ describes a whole revolution of the rotor herein. The rotational angle interval Δφ therefore corresponds to a mechanical rotational angle interval of 360°. Since the rotor in the present case has three pole pairs, the rotational angle interval Δφ also corresponds to an electrical rotational angle interval of 1080°. The actual phase currents thus cover three periods in the rotational angle interval Δφ. Accordingly, the rotational angle interval Δφ has three electrical rotational angle intervals Δφ1, Δφ2, Δφ3, each of which corresponds to an electrical rotational angle of 360°.

As can be seen in FIG. 3, the actual phase currents are overlaid by an interference wave SW. The interference wave SW causes the different maxima and minima of the phase currents to differ from each other. For example, a first maximum M1 of the actual phase current IU is greater than a second maximum M2 of the actual phase current IU. In the present case, the interference wave SW results from the compression cycles of the compressor 2. If the conveyed fluid is compressed by the compressor 2, the actual phase currents are increased. Since the compressor 2 is designed as a twin rotary piston compressor 2, and in this respect, passes through two compression cycles with each revolution of the rotor, the interference wave SW is the first harmonic wave relative to the rotation frequency of the rotor.

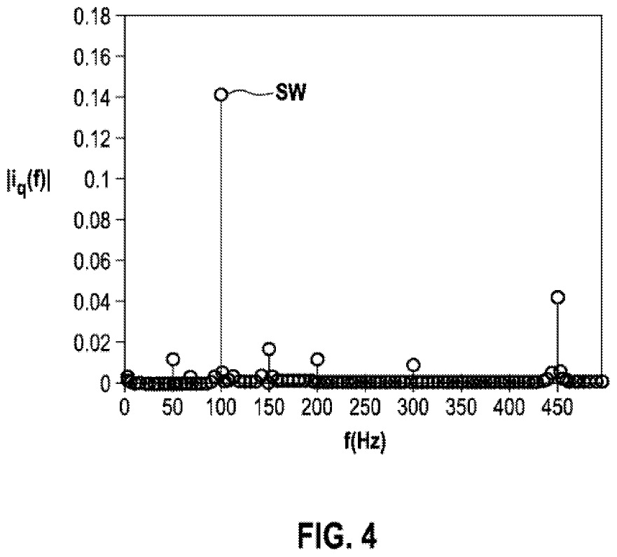

FIG. 4 shows a spectrum of the torque-forming current iq. The spectrum was determined by a Fourier transformation of the torque-forming current iq. As can be seen in FIG. 4, the spectrum has a signal at a frequency of 100 Hz in the present case. This signal corresponds to the interference wave SW. The vibrations therefore also affect a course of the torque-forming current iq, so that the torque-forming current can also be considered to constitute the actual variable. Analogously, the flow-forming current id can also be considered to constitute the actual variable.

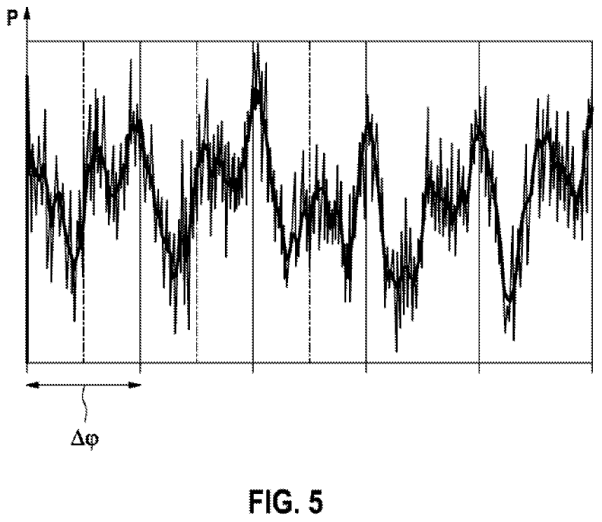

FIG. 5 shows a path of the fluid pressure P sensed by the second sensor device 14. In the present case, the fluid pressure P of a low-pressure portion of the compressor 2 is shown. As can be seen from FIG. 2, the path of the fluid pressure P is also influenced by the interference wave SW. In this respect, the fluid pressure P current can also be considered to constitute the actual variable.

In the following, it is assumed that in step S3, the torque-forming current iq is determined as the actual variable and monitored for interference waves. According to further embodiment examples, at least one actual phase flow, the flow-forming flow id, the fluid pressure P of the low-pressure section of the compressor 2, or the fluid pressure of a high-pressure section of the compressor 2, is determined as the actual variable and monitored for interference waves.

In a fourth step S4, an interference-wave correction instruction for compensation of the interference wave SW related to the selected reference rotational angle φRef is determined. An interference-wave correction instruction is understood to refer to data whose consideration when controlling the electric machine 7 results in the interference wave SW being smoothed. The interference wave SW is then no longer visible in the course of the actual variable. In the present case, the control unit 11 determines the interference-wave correction instruction depending on a sensor signal of an NVH sensor. An NVH sensor is a sensor designed to sense the vibrations mentioned above. For example, the NVH sensor consists of an accelerometer, a laser sensor, or an acoustic sensor. The NVH sensor is only associated with the electric machine 7 to perform the method shown in FIG. 2. In this regard, the NVH sensor preferably consists of an external sensor. Preferably, the control unit 11 alters the actuation of the electric machine 7 in such a manner that the sensor signal of the NVH sensor is reduced or minimized. The control unit 11 then determines the necessary change in the actuation as an interference-wave correction instruction. Since periodically occurring effects are to be reduced by the interference-wave correction instruction, the interference-wave correction instruction itself is also periodic. The phase position of the periodic interference-wave correction instruction herein makes reference to the selected reference rotational angle φRef.

In a fifth step S5, the control unit 11 determines a reference feature of the interference wave SW based on the reference rotational angle φRef. A reference feature is understood to consist of an attribute of the interference wave SW that is feature for the selected reference rotational angle φRef. The reference rotational angle φRef has a rotational angle value of 0° relative to the electrical rotational angle interval Δφ1. The electrical rotational angle interval Δφ2 and the electrical rotational angle interval Δφ3 each also have a rotational angle with a rotational angle value of 0°, namely, the rotational angles φ1 and φ2. For example, a phase position of the interference wave SW is determined as the reference feature based on the reference rotational angle φRef. As can be seen in FIG. 3, for example, the phase position of the interference wave SW with respect to the reference rotational angle φRef is different from that with respect to the rotational angle φ1 or the rotational angle φ2. In this respect, the phase position is suitable for clearly characterizing the reference rotational angle φRef as the reference feature.

In a sixth step S6, the rotational angle value of the reference rotational angle φRef is determined as the reference rotational angle value based on the electrical rotational angle interval Δφ1. As already mentioned, this is 0°.

In a seventh step S7, the determined interference correction instruction, the determined reference rotational angle value and the determined reference feature are associated with each other, and are saved as correction information in the data storage 12.

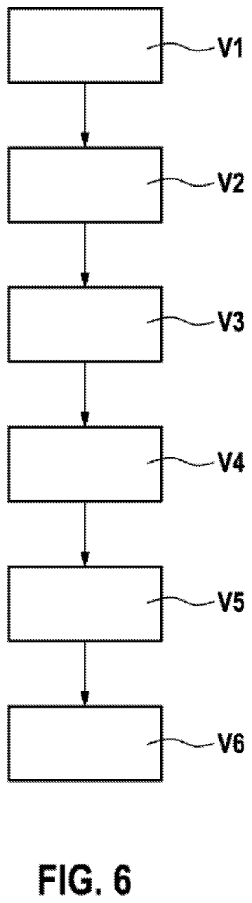

In the following, an advantageous method for controlling the electric machine 7 is explained in further detail using FIG. 6. The method shown in FIG. 6 is also performed by the control unit 11.

In a first step V1, the electric machine 7 is driven by means of a field-oriented control based on an estimated electrical rotational angle. Step V1 therefore corresponds to step S1 of the method shown in FIG. 2.

In a second step V2, the correction information determined according to the method shown in FIG. 2 is provided to the control unit 11.

In a third step V3, an actual variable influenced by the rotation of the rotor is determined and monitored for interference waves. The same actual variables mentioned above with respect to process step S4 are considered. Preferably, the actual variable is determined as the actual variable that was also considered when determining the correction information in step S4.

When an interference wave is detected, a respective actual feature of the interference wave is determined for each electrical rotational angle of the rotor whose rotational angle value corresponds to the reference rotational angle value in a fourth step V4. As mentioned above, the electrical rotational angle values of the rotational angles φRef, φ1 and φ2 correspond to the reference rotational angle value that is included in the correction information. Accordingly, one actual feature of the interference wave is determined for each of these three rotational angles. Preferably, an actual feature that is substantially the same as the reference feature that is included in the correction information is determined. If the phase position of the interference wave was therefore determined as the reference feature in step S5, then the phase position of the interference wave SW is also determined as the actual feature for each of the rotational angles φRef, φ1 and φ2 in step V4.

In a fifth step V5, the determined actual features are compared with the reference feature. In addition, the actual feature which has the least deviation from the reference feature is selected. It is herein assumed that the electrical rotational angle for which this actual feature was determined is the reference rotational angle φRef.

In a sixth step V6, the phase position of the interference-wave correction instruction included in the correction information is determined. Since the interference-wave correction instruction is related to the reference rotational angle and the reference rotational angle φRef was identified in step V5 based on the comparison of the actual feature with the reference feature, this is easily possible. After determining the phase position of the interference-wave correction instruction, the actuation signals for the electric machine 7 are then determined depending on the interference-wave correction instruction with the specified phase position. This compensates for the interference wave SW so that the vibrations during operation of the electric machine 7 are reduced.

The electric machine 7 is actuated—in particular controlled—by the determined actuation signals. The actuation of the electric machine 7 is carried out by means of the actuation signals. Preferably, the method of controlling the electric machine 7 comprises the actuation of the electric machine using the determined actuation signals.

1. A method for determining correction information for an electric machine (7) which has a stator winding and a rotatably mounted rotor with multiple pole pairs, the method comprising:
selecting a reference rotational angle (φRef) of the rotor,
determining an actual variable influenced by rotation of the rotor, and
monitoring the actual variable for interference waves (SW), wherein
when an interference wave (SW) is detected, an interference-wave correction instruction related to the reference rotational angle (φRef) to compensate the detected interference wave (SW) as well as a reference feature of the interference wave (SW) related to the reference rotational angle (φRef) are determined via a control unit, wherein
a reference rotational angle value of the reference rotational angle (φRef) is determined, via the control unit, based on a rotational angle interval (Δφ1) that is covered in an electrical revolution of the rotor, and wherein
the determined interference-wave correction instruction, the determined reference feature, and the determined reference rotational angle value are associated with each other and stored as correction information.

2. The method according to claim 1, wherein the interference-wave correction instruction is determined depending on a sensor signal of an NVH sensor.

3. The method according to claim 1, wherein at least one actual electrical phase current (IU, IV, IW) flowing through the stator winding is determined as the actual variable.

4. The method according to claim 1, wherein a torque-forming current (iq) is determined as the actual variable and/or that a flow-forming current (id) is determined as the actual variable.

5. The method according to claim 1, wherein the machine (7) is designed to drive a compressor (2), wherein a fluid pressure (P) of a fluid conveyed by the compressor (2) is determined as the actual variable.

6. The method according to claim 1, wherein a phase position of the interference wave (SW) is determined as the reference feature.

7. The method according to claim 1, wherein at least one maximum and/or at least one minimum of the actual variable is determined as the reference feature.

8. A method for controlling an electric machine (7) including a stator winding and a rotatably mounted rotor having multiple pole pairs, the method comprising:
providing, via a control unit, correction information that has an interference-wave correction instruction, an electrical reference rotational angle value and a reference feature,
determining, via the control unit, an actual variable influenced by rotation of the rotor,
monitoring the actual variable for interference waves (SW), wherein when an interference wave (SW) is detected, an actual feature of the interference wave (SW) related to the electrical rotational angle (φRef, φ1, φ2) is determined in each case for each electrical rotational angle (φRef, φ1, φ2) of the rotor whose rotational angle value corresponds to the reference rotational angle value via the control unit, wherein the determined actual features are compared with the reference feature, wherein a phase position of the interference-wave correction instruction is determined depending on the comparison, and wherein actuation signals for the electric machine (7) are determined depending on the interference-wave correction instruction with the determined phase position.

9. The method according to claim 8, wherein the electric machine (7) is actuated or controlled by means of the determined actuation signals.

10. A device for determining correction information for an electric machine, wherein the machine (7) includes a stator winding and a rotatably mounted rotor having multiple pole pairs, wherein the device comprises a control unit (11) that is configured to
select a reference rotational angle (φRef) of the rotor,
determine an actual variable influenced by rotation of the rotor, and
monitor the actual variable for interference waves (SW), wherein
when an interference wave (SW) is detected, an interference-wave correction instruction related to the reference rotational angle (φRef) to compensate the detected interference wave (SW) as well as a reference feature of the interference wave (SW) related to the reference rotational angle (φRef) are determined, wherein
a reference rotational angle value of the reference rotational angle (φRef) is determined based on a rotational angle interval (Δφ1) that is covered in an electrical revolution of the rotor, and wherein the determined interference-wave correction instruction, the determined reference feature, and the determined reference rotational angle value are associated with each other and stored as correction information.

11. A device for controlling an electric machine, wherein the machine (7) includes a stator winding and a rotatably mounted rotor having at least two pole pairs, wherein the device comprises a control unit (11) configured to:
provide correction information that has an interference-wave correction instruction, an electrical reference rotational angle value and a reference feature,
determine an actual variable influenced by rotation of the rotor,
monitor the actual variable for interference waves (SW), wherein
when an interference wave (SW) is detected, an actual feature of the interference wave (SW) related to the electrical rotational angle (φRef, φ1, φ2) is determined in each case for each electrical rotational angle (φRef, φ1, φ2) of the rotor whose rotational angle value corresponds to the reference rotational angle value via the control unit, wherein the determined actual features are compared with the reference feature, wherein a phase position of the interference-wave correction instruction is determined depending on the comparison, and wherein actuation signals for the electric machine (7) are determined depending on the interference-wave correction instruction with the determined phase position.

12. An electrical drive device comprising:
an electric machine (7) and having a device (10) for operating the electric machine, wherein the configuration of the device (10) according to claim 11.

13. A heat pump having a compressor (2) and an electrical drive device (6) for driving the compressor (2), wherein the design of the drive device (6) according to claim 12.
